(19) United States
(12) Patent Application Publication
(10) Pub. No.: US 2007/0028432 A1
(43) Pub. Date: Feb. 8, 2007

(54) Apparatus and method for separating composite panels into metal skins and polymer cores

(75) Inventors: James C. Evans, Eastman, GA (US); William Stanley May, Eastman, GA (US); Joe C. Peace JR., Dacula, GA (US); Charles E. Smith, Cochran, GA (US)

Correspondence Address: William F. Lang, IV;Eckert Seamans Cherin & Mellott, LLC, 600 Grant Street, 44th Floor, Pittsburgh, PA, 15219, US

(73) Assignee: Alcoa, Inc., Pittsburgh, PA (US)

(21) Appl. No.: 11/196,013

(22) Filed: Aug. 3, 2005

(51) Int. Cl. B23P 19/00

(52) U.S. Cl. 29/18.1; 29/403.3; 29/426.1

(57) ABSTRACT

Composite panels are separated into their component materials of metal skins and polymer cores by dimpling the metal skins to create stresses between the metal skins and polymer cores, heating the metal skins to partially separate them from the polymer core, and then pulling the metal skins away from the polymer core.

### BACKGROUND INFORMATION

1. Field of the Invention

The present invention relates to the recovery of aluminum for recycling. More specifically, the invention provides an apparatus and method for separating the metal skins from the polymer cores of composite panels.

2. Description of the Related Art

In order to recycle composite waste material, it is necessary to separate the various component materials of the composite waste material so that each material may be reused separately, thereby preserving the original properties of each material.

An example of a presently available means of separating waste material is described in U.S. Pat. No. 4,119,453, issued to M. Knezevich on Oct. 10, 1978, disclosing a process for reclaiming thin-walled malleable waste material. The process includes cutting or grinding the material to a suitable size, and then placing the waste in a shot mill, wherein the rotating blades repeatedly impact the waste material until it takes the approximate shape of a spheroid. Forming all of the waste into approximately the same shape facilitates specific gravity separation of the waste by material type for recycling.

U.S. Pat. No. 5,133,505, issued to G. F. Bourcier et al, on Jul. 28, 1992, discloses a method of separating aluminum alloys. The articles to be separated are first shredded, and then mechanically separated by particle size. A magnetic field generated by a linear induction motor is then used to displace the particles of each predetermined size, with the displacement distance being determined by the electrical conductivity of the materials within the particles.

U.S. Pat. No. 5,311,830, issued to G. H. Kiss on May 17, 1994, discloses a method and apparatus for storage, transport, and preparation of waste goods. The apparatus includes a heatable container disposed above the molten bath tank. A ramming device such as a gravity or hydraulically driven hammer is used to crush the contents of the heatable tube and push them towards the molten bath tank. The waste being driven from the heatable tube to the molten bath has a sufficiently high temperature to cause the mineralization of the pyrolysis residues, thereby guaranteeing a leach-out proof binding of all pollutants. Any glass within the pyrolysis goods furthers these properties, thereby eliminating the need to sort out the glass prior to pyrolysis. The temperature of the molten bath may be selected to fractionally withdraw mineralized substances from the bath.

U.S. Pat. No. 5,323,971, issued to S. Nishibori et al on Jun. 28, 1994, discloses the separation of resin material from a resin film thereon so that each may be recovered separately. The resin article is first crushed into small pieces, and then subject to vibrations applied by compression impact applying members. The difference in internal stresses between the resin material and resin film is such that the resin film is more difficult to squeeze and elongate. The resin film is thereby separated from the resin material during the vibration process. Unlike the present invention, this method requires the additional step of crushing the article into small pieces.

U.S. Pat. No. 6,152,260, issued to K. Eipper et al. on Nov. 28, 2000, discloses a method of filling cavities in workpieces. Thermally soluble powdered carbon is placed within the cavity, possibly within an aluminum pouch, and then heated, causing the powdered carbon to swell and fill the cavity as carbon foam.

U.S. Pat. No. 6,455,148, issued to R. P. Spears et al., on Sep. 24, 2002, discloses a composite panel having a foamed plastic core adhesively secured on opposing sides to metallic outer skin layers.

Only one of the above references discloses a means of separating a metal skin of a composite panel from the polymer core of the panel, and that method requires the additional step of crushing the composite article. Accordingly, there is a need for a method of separating the metal skins of composite panels from the polymer cores of the panels, thereby permitting both the skins and the cores to be processed separately for recycling. There is a further need for an apparatus capable of utilizing the method.

### SUMMARY OF THE INVENTION

The present invention provides an apparatus and method for separating the metal skins of composite panels from the polymer cores of these panels.

The method of the present invention includes the steps of deforming the metal skin of the composite panel, with the deformations possibly taking the form of dimples within the surface. These dimples will cause stresses within the composite panel. Upon heating the metal skin, the stress created by the dimples within the metal skin and between the metal skin and the polymer core will cause the metal skin to partially separate from the polymer core. The metal skin may then be pulled away from the polymer core to separate the composite panel into its component materials.

An apparatus for performing the above method may include a pair of drive rolls having protrusions extending therefrom. The apparatus includes a heater adjacent to the drive rolls, so that material exiting the drive rolls will enter the heater. A pair of separator rolls may be located after the heater, with the separator rolls having a plurality of teeth extending from their circumference. The teeth are structured to deform the metal sheets and thereby frictionally engage the metal sheets. It is possible but not necessary for the teeth to pierce the metal sheets. A stripper is located adjacent to each separator roll, being structured to disengage the metal skin from the separator roll once the metal skin has been separated from the polymer core.

Typically, it is desirable to heat the composite sheet quickly after dimpling, to minimize the extent to which the polymer core absorbs heat. The goal is to heat the aluminum skin sufficiently so that the stresses created by the dimples will cause the aluminum skin to separate from the polymer core, without excessively melting the polymer core. Some embodiments of the present invention will utilize a heating time of about 8 seconds to about 24 seconds, which, at a temperature of about 300° F. to about 400° F. (about 150° C. to about 204° C.), is sufficient to separate the metal skins from the polymer core when a dimple depth of about 1/16 inch (1.6 mm.) is used.

Accordingly, it is an object of the present invention to provide a method of separating metal skins from a polymer core of a composite panel.

It is another object of the invention to provide an apparatus for separating the metal skins from the polymer core of a composite panel.

It is a further object of the invention to provide an apparatus and method for deforming the metal skin of a polymer panel, heating the metal skin, and separating the metal skin from the polymer core of the composite panel.

It is another object of the invention to provide a method of heating the composite panel after dimpling the metal skin in a manner that will cause the aluminum skin to absorb the sufficient heat so that the stresses caused by the dimpling will separate the aluminum skin from the polymer core, without excessively melting the polymer core.

These and other objects of the invention will become more apparent through the following description and drawings.

### BRIEF DESCRIPTION OF THE DRAWINGS

FIG. 1 is a diagrammatic side view of an apparatus for separating the metal skins from the polymer core of a composite panel according to the present invention.

FIG. 2 is an isometric inlet end view of an apparatus for separating metal skins from polymer cores according to the present invention.

FIG. 3 is an isometric side view of the inlet and outlet rolls for an apparatus for separating the metal skins from the polymer cores of a composite panel according to the present invention.

FIG. 4 is a side view of a heater or oven for an apparatus for separating the metal skins from the polymer cores of a composite panel according to the present invention, showing the oven separated from the remainder of the apparatus for clarity.

FIG. 5 is an isometric view of the exit end of an apparatus for separating the metal skins from the polymer cores of a composite panel according to the present invention.

Like reference characters denote like elements throughout the drawings.

### DETAILED DESCRIPTION OF THE PREFERRED EMBODIMENT

The present invention provides an apparatus and method for separating the metal skin of a composite material from the polymer core of that material.

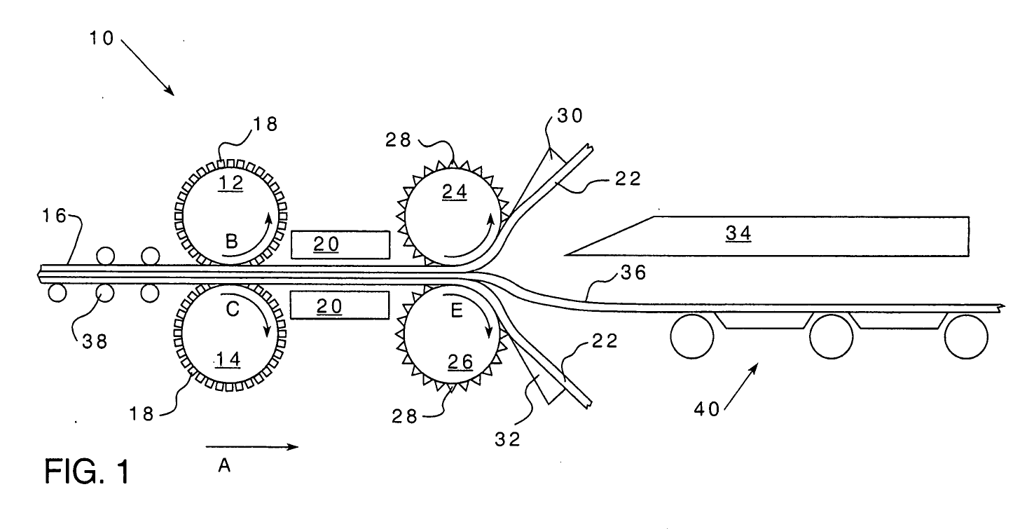

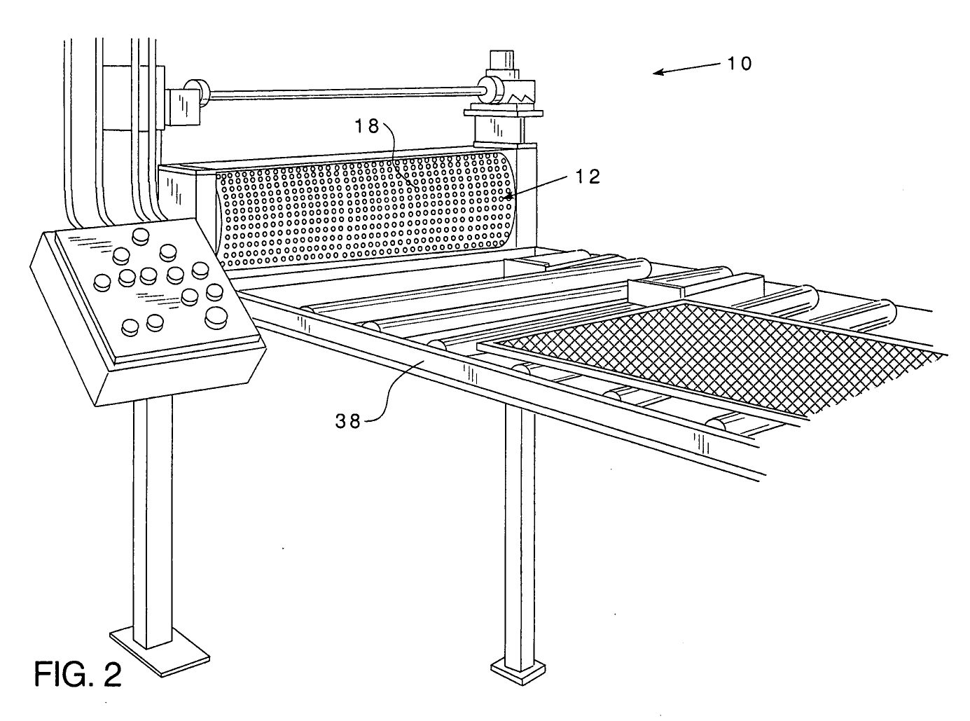

An apparatus of the present invention is illustrated schematically in FIG. 1, and in more detail in FIGS. 2-5. Referring to FIGS. 1-3, the apparatus 10 includes a pair of drive rolls 12, 14, mounted adjacent to each other and structured to drive a composite panel 16 therebetween in the direction of arrow A when the drive rolls 12, 14 are rotated in the directions of arrows B and C respectively. Each of the drive rolls 12, 14 defines a plurality of protrusions 18 around its circumference. The protrusions 18 extend outward from the drive rolls 12, 14 by a distance that is preferably about 5/16 inch (7.9 mm.), which has been found to produce a dimple depth of about 1/16 inch (1.6 mm.). The protrusions 18 will preferably be separated by a distance of about 2 inches (50.8 mm.), and are preferably arranged in a staggered pattern, with adjacent rows being staggered with respect to each other. The protrusions 18 on the drive roller 12 are preferably staggered with respect to the protrusions 18 on the drive roller 14. Some preferred embodiments of the apparatus 10 may utilize the protrusions 18 in the form of captive screws or set screws. The optimum spacing of the protrusions may change depending on the type of polymer used and the type, thickness, and temper of the metal skins.

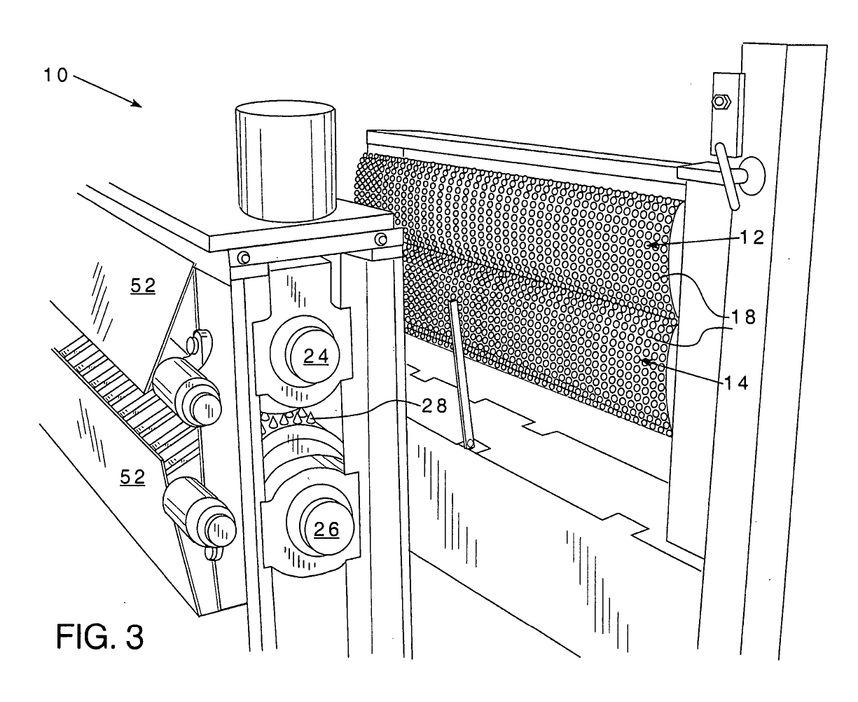

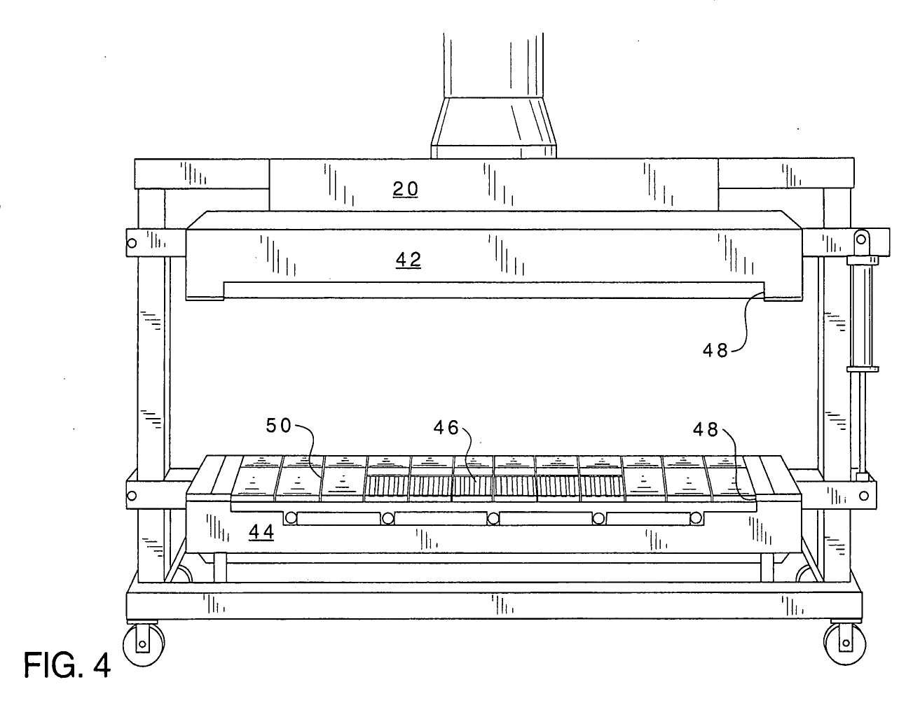

Referring to FIGS. 1 and 3, a heater 20 is located adjacent to the drive rolls 12, 14, and sequentially after the drive rolls 12, 14 in the direction of arrow A. The heater 20 is preferably an infrared heater, but other heaters, for example induction heaters and gas burner type heaters, may be utilized. Preferred infrared heaters will produce heat in the range of about 100 watts/in.² and about 200 watts/in.². The example of the heater 20 that is illustrated in FIG. 4 is an infrared heater having a top half 42 and bottom half 44. Each of the top half 42 and bottom half 44 of the heater 20 includes a plurality of heating elements 46. A channel 48 is defined between the top half 42 and bottom half 44. A guard 50 is disposed along the top and bottom edges of the channel 48, being most visible along the bottom edge in FIG. 4. The guard 50 protects the heating elements 46 from damage as composite panels are passing through the heater 20. The heater 20 is preferably structured to heat the aluminum skins 22 of the composite panel 16 to a temperature between about 300° F. (150° C.) to about 400° F. (204° C.), and for a time period between about 8 seconds to about 2.7 seconds. One preferred embodiment of the heater 20 is about 8′ long, which produces the desired heating time with a material feed rate of about 5 ft./min. (1.5 m./min.) to about 15 ft./min. (4.6 m./min.).

Referring to FIGS. 1, 3, and 5, a pair of separator rolls 24, 26 is located adjacent to the heater 20, and sequentially after the heater 20 in the direction of arrow A. The separator rolls 24, 26 are structured to engage the composite panel 16, so that the teeth 28 surrounding each of the separator rolls 24, 26 will deform and frictionally engage the aluminum skin 22 of the composite panel 16. It is possible but not necessary that the teeth 28 will penetrate the aluminum skin 22. The teeth 28 preferably extend a distance of about 5/16 inch (7.9 mm.) from the separator rolls 24, 26, and are themselves separated by a distance of about 4 inches (101.6 mm.). A guard 52 may be disposed adjacent to the separator rolls 24, 26 to protect any human operator standing in close proximity to the apparatus during its operation.

A stripper 30, 32 is disposed adjacent each of the separator rolls 24, 26, respectively, and is structured to strip the metal skins 22 from the separator rolls 24, 26 as the separator rolls 24, 26 rotate in the direction of arrows D and E, respectively. Each stripper 30, 32 includes a plurality of fingers 54 structured to fit between the teeth 28, enabling the fingers 54 to fit between the metal skins 22 and the rolls 24, 26, thereby separating the metal skins 22 from the rolls 24, 26. A separator shelf 34 is disposed partially below and sequentially after the stripper 30, so that the metal skin 22 separated from the roller 24 by the stripper 30 does not come in contact with the polymer core 36 from which the metal skin 22 has just been separated.

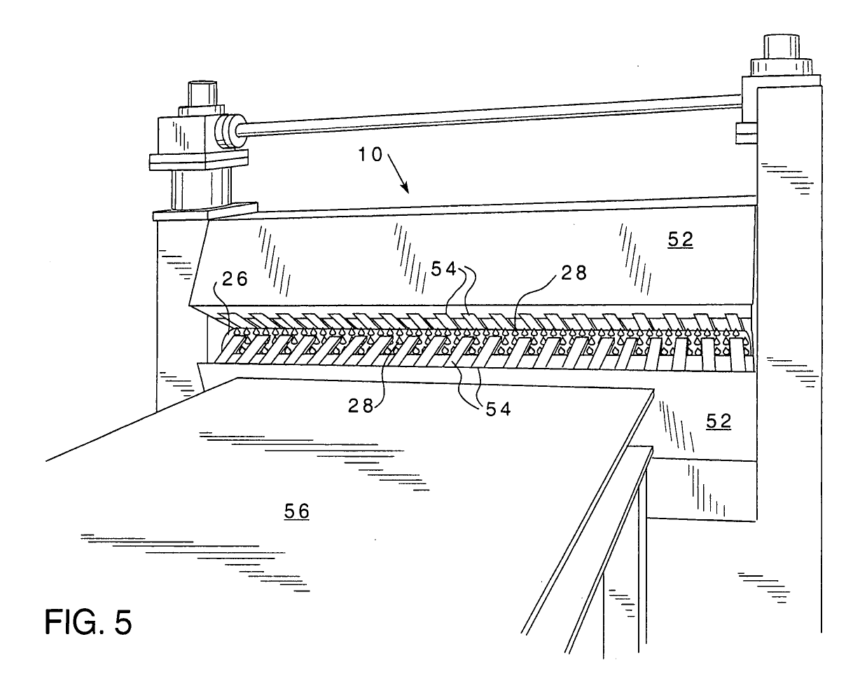

The apparatus 10 further includes an infeed conveyor 38 disposed adjacent to the drive rolls 12, 14, and sequentially before the drive rolls 12, 14 in the direction of arrow A, and an exit conveyor 40 (FIG. 1) or exit table 56 (FIG. 5) for carrying the polymer core 36 away from the apparatus 10 after separation of the metal skins 22.

In use, a composite panel 16 will be fed between the drive rolls 12, 14 through the infeed conveyor 38. The protrusions 18 on the drive rolls 12, 14 will produce dimples within the metal skins 22 of the composite panel 16, thereby creating various stresses between the metal skins 22 and polymer core 36. As the composite panel 16 passes through the heater 20, the metal skins 22 are heated to a sufficient temperature so that the stresses created by the dimples will cause the metal skins 22 to partially separate from the core 36, without transferring excessive heat to the core 36 and excessively melting the core 36. The metal skins 22 are next frictionally engaged by the teeth 28 of the separator rolls 24, 26, which pull the metal skins 22 away from the core 36 as they rotate. Continued rotation of the separator rolls 24, 26 drives the metal skins 22 against the strippers 30, 32, thereby separating the metal skins 22 from the separator rolls 24, 26. The metal skins 22 and polymer core 36 may then be separately recovered for recycling.

The present invention may be used with composite panels having cores made from polymers such as pure polyethylene or polyethylene with up to at least about 80% fillers such as presently available fire retardant fillers known to those skilled in the art of composite panels. The invention has successfully been used with composite panels having skins made from aluminum, aluminum alloys, stainless steels, and carbon steels. It may be used with any composite panel for which the specific heat of the skin is sufficient to resist heat transfer to the polymer core long enough for the skin to separate from the core after deformation of the skin.

The present invention therefore provides an apparatus and method for separating aluminum skins 22 from the core 36 of a composite panel 16, thereby permitting the aluminum skins 22 and polymer core 36 to be recycled separately.

While a specific embodiment of the invention has been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the appended claims and any and all equivalents thereof.

What is claimed is:

1. A method of separating a metal skin of a composite material from a polymer core, the method comprising:
deforming the metal skin;
heating the metal skin; and
separating the metal skin from the polymer core.

2. The method according to claim 1, wherein deforming the metal skin is performed by passing the composite material between a pair of deforming rolls, each of the deforming rolls defining protrusions about its circumference.

3. The method according to claim 2, wherein the protrusions extend outward from the deforming rolls for a distance of about 5/16inch (7.9 mm.).

4. The method according to claim 2, wherein the protrusions are separated by a distance of about 2 inches (50.8 mm.).

5. The method according to claim 2, wherein the protrusions are in a form selected from the group consisting of captive screws and set screws.

6. The method according to claim 2, wherein the protrusions are arranged in a pattern of rows, with the protrusions in ad adjacent rows being staggered with respect to each other.

7. The method accordingly to claim 6, wherein the protrusions on the upper and lower drive rolls are staggered with respect to each other.

8. The method according to claim 2, wherein the protrusions are structured to deform the metal skin to a depth of about 1/16 inch to ⅛ inch (1.6 mm. to 3.2 mm.).

9. The method according to claim 1, wherein the composite material is subjected to a temperature between about 300° F. (150° C.) to about 400° F. (204° C.).

10. The method according to claim 1, wherein the composite material is heated for a time period of about 2.7 seconds to about 8 seconds.

11. The method according to claim 1, wherein heating the metal skin is accomplished by a means selected from the group consisting of infrared heating, gas burner heating, and induction heating.

12. The method according to claim 1, wherein separating the metal skin from the polymer core is performed by passing the composite material between a pair of separating rolls, each separating roller having a plurality of teeth about its circumference, the teeth being structured to frictionally secure the metal skins to the separating rolls.

13. The method according to claim 12, wherein the teeth extend a distance of about 5/16 inch (7.9 mm.) from each separating roller.

14. The method according to claim 12, wherein the teeth are separated by a distance of about 4 inches (101.6 mm.).

15. An apparatus for separating a metal skin of a composite material from a polymer core, the apparatus comprising:
a pair of deforming rolls, each deforming roller having a plurality of protrusions extending from its circumference.
a heat source; and
a pair of separating rolls, each separating roller having a plurality of teeth extending from its circumference.

16. The apparatus according to claim 15, wherein the protrusions extend outward from the deforming rolls for a distance of about 5/16 inch (7.9 mm.).

17. The apparatus according to claim 15, wherein the protrusions are separated by a distance of about 2 inches (50.8 mm.).

18. The apparatus according to claim 15, wherein the protrusions are in a form selected from the group consisting of captive screws and set screws.

19. The apparatus according to claim 15, wherein the protrusions are arranged in a pattern of rows, with the protrusions in adjacent rows being staggered with respect to each other.

20. The apparatus according to claim 19, wherein the protrusions on the upper and lower drive rolls are staggered with respect to each other.

21. The apparatus according to claim 15, wherein the protrusions are structured to deform the metal skin to a depth of about 1/16 inch to about ⅛ inch (1.6 mm. to 3.2 mm.).

22. The apparatus according to claim 15, wherein the heat source is selected from the group consisting of an infrared heater, a gas heater, and an induction heater.

23. The apparatus according to claim 15, wherein the teeth extend a distance of about 5/16 inch (7.9 mm.) from each separating roller.

24. The apparatus according to claim 15, wherein the teeth are separated by a distance of about 4 inches (101.6 mm.).

25. The apparatus according to claim 15, further comprising a stripper disposed adjacent to each separating roller, the stripper being structured to separate the metal skins from one of the separating rolls.

26. The apparatus according to claim 15, further comprising means for feeding composite material to the deforming rolls.

27. The apparatus according to claim 26, wherein the means for feeding composite material to the deforming rolls is an infeed conveyor.
